(19) United States
(12) Patent Application Publication
(10) Pub. No.: US 2014/0189357 A1
(43) Pub. Date: Jul. 3, 2014

(54) ENCRYPTION AND AUTHENTICATION BASED NETWORK MANAGEMENT METHOD AND APPARATUS

(71) Applicant: Electronics and Telecommunications Research Institute, Daejeon-si (KR)

(72) Inventors: Soo-Myung PARK, Daejeon-si (KR); Sung-Hyuk BYUN, Daejeon-si (KR)

(73) Assignee: Electronics and Telecommunications Research Institute, Daejeon-si (KR)

(21) Appl. No.: 14/084,572

(22) Filed: Nov. 19, 2013

(30) Foreign Application Priority Data
Jan. 2, 2013 (KR) 10-2013-0000305

(51) Int. Cl. H04L 29/06

(52) U.S. Cl. CPC H04L 63/0428
USPC 713/171

(57) ABSTRACT

Disclosed are an encryption and authentication-based network management method and apparatus. A network management method according to an embodiment of the present invention includes: generating a public key and a private key for encryption and decryption of network attribute information to be used by a virtual machine positioned in the network server to provide the generated public key to a database; receiving network attribute information encrypted by the database with the public key from the database; and decrypting the received network attribute information with the private key to authenticate the network attribute information.

### CROSS-REFERENCE TO RELATED APPLICATION

This application claims the benefit under 35 U.S.C. §119(a) of a Korean Patent Application No. 10-2013-0000305, filed on Jan. 2, 2013, the entire disclosure of which is incorporated herein by reference for all purposes.

### BACKGROUND

1. Field

The present invention relates to a technology for integrated and automated network management and control in an Internet data center (IDC) network for providing a cloud service.

2. Description of the Related Art

In addition to the rapid change in cloud service and the technical advance in elements in an Internet data center (IDC), an IDC network requires network control technology optimized for the cloud service, network control technology for enhancement of network resource use efficiency and communication efficiency, cloud and network resource control technology, and integrated high-reliability network control technology in order to accommodate functional requirements of a network according to the change in service.

In this regard, the IETF Transparent Interconnection of Lots of Links (TRILL) standard, the IEEE 802.1Qbh Bridge Port Extension standard, the IEEE802.1Qbg Edge Virtual Bridging (VSI discovery and configuration protocol: VDP, S-Channel Discovery and Configuration Protocol: CDCP, Edge Control Protocol: ECP) standard, etc. are being developed. Related major companies Cisco, Juniper, and Brocade are developing products on the basis of the related standards.

IEEE802.1Qbg technology is auto-managed IDC network control technology, and supports smart setup of a cloud server area and a network area to avoid complicated and time-consuming operations upon manually setting a management area between the cloud server area and the network area with increase in the volume of the IDC network for the cloud service.

### SUMMARY

The following description relates to an encryption and authentication-based network management method and apparatus, which can correct continuity and quality of a cloud service in an IDC network.

In one general aspect, a network management method of a network device includes: generating a public key and a private key for encryption and decryption of network attribute information to be used by a virtual machine positioned in the network server to provide the generated public key to a database; receiving network attribute information encrypted by the database with the public key from the database; and decrypting the received network attribute information with the private key to authenticate the network attribute information.

The network attribute information may be virtual station interface type information, which may include at least one of a virtual LAN identifier, a MAC address, Quality of Service control information, an access control list, and security control information.

In the authenticating of the network attribute information, the network device may receive hacked network attribute information from a hacked system, decrypt the received network attribute information with the private key to determine appropriateness of the network attribute information, and discard the network attribute information.

The network management method may further include setting a network for the virtual machine using the authenticated network attribute information. At this point, the network device may automatically set the network using a virtual station interface discovery and configuration protocol.

The network management method may include: receiving a request for network setting to be used by the virtual machine from the network server and then requesting the network attribute information from the database; receiving the network attribute information encrypted with the public key from the database; and decrypting the received network attribute information with the private key to authenticate the network attribute information and setting the network for the virtual machine using the authenticated network attribute information.

The requesting of the network attribute information may include: determining whether the network attribute information contained in a network setting request message of the network server is in a local database; and requesting the network attribute information from the database when the network attribute information is not in the local database.

The network device connected with the network server may be external to the network server in order to support the communication between the virtual machines.

In another general aspect, a network management method of a database includes: updating, by a network manager, network attribute information; receiving a public key from a network device connected with a network server having a virtual machine; updating a mapping table mapping the public key onto a network device list for receiving the network attribute information; and encrypting the updated network attribute information with the received public key and then transmitting the network device according to the updated mapping table.

The network management method further includes: receiving the network attribute information from the network device according to the request of the network server; retrieving the registered network device list and the requested network attribute information according to the network attribute information request; and encrypting the retrieved network attribute information with the public key to respond to the network device.

In another general aspect, a network management apparatus includes: a key generation unit configured to generate a public key and a private key for encryption and decryption of network attribute information to be used by a virtual machine of a network server; a communication unit configured to provide the public key generated by the key generation unit to a database, and when the database encrypts network attribute information with the public key, receive the encrypted network attribute information from the database; and an authentication unit configured to decrypt the network attribute information received through the communication unit with the private key to authenticate the network attribute information.

Other features and aspects will be apparent from the following detailed description, the drawings, and the claims.

### BRIEF DESCRIPTION OF THE DRAWINGS

FIG. 1 is a block diagram showing an Internet data center (IDC) network according to the present invention.

FIG. 2 is a flowchart showing a control message flow for transmitting VSI type information between a VSI type DB and a second network device of an IDC center for providing a cloud service according to an embodiment of the present invention.

FIG. 3 is a flowchart showing a control message flow for transmitting VSI type information between a VSI type DB and a second network device of an IDC center for providing a cloud service according to another embodiment of the present invention.

FIG. 4 is a block diagram showing a second network device according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Also, the terms described below are defined with consideration of the functions in the present invention, and thus may vary depending on a user, intention of an operator, or custom. Accordingly, the definition would be made on the basis of the whole specification.

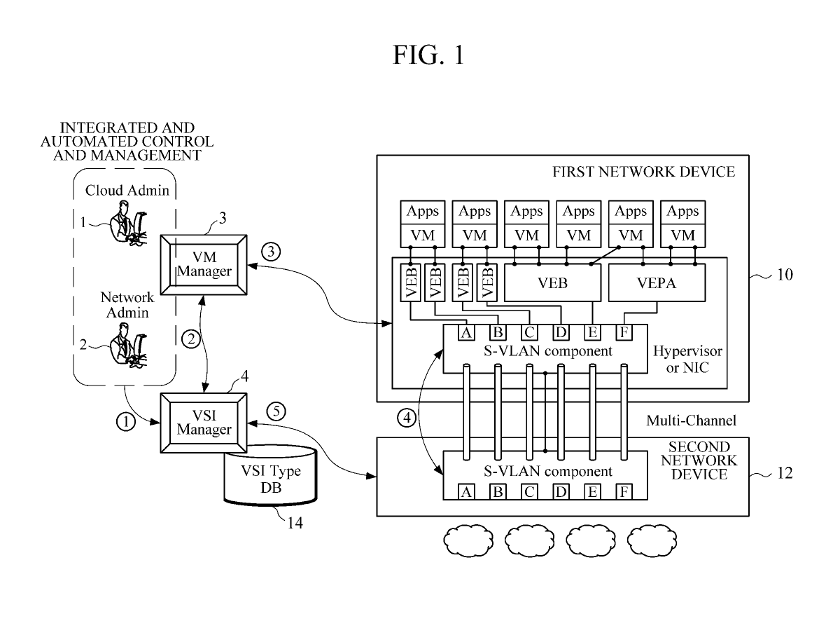

FIG. 1 is a block diagram showing an Internet data center (IDC) network according to the present invention.

Referring to FIG. 1, the IDC network includes a first network device 10 and a second network device 12.

The first network device 10 and the second network device 12 are connected through multiple channels. The first network device 10 may be a physical server, and the second network device 12 may be a switch, but they are not limited thereto. That is, the network devices 10 and 12 may each be any suitable network device, such as a personal computer, mainframe, mobile device, router, bridge, switch, set-top box, modem, or head-end.

The first network device 10 includes a plurality of virtual machines (VMs), applications, and a hypervisor or network interface card (NIC).

The first network device 10 may internally process traffic with virtual Ethernet bridging (VEB), and process traffic through the external second network device 12 using protocols such as virtual Ethernet port aggregation (VEPA), for communication between the VMs.

The second network device 12 may be similar to the first network device 10 in many aspects. In this regard, the second network device 12 may include a logic, a circuit, interfaces, and codes for participating in network communications according to one or more networking standards to process data. The second network device 12 may support VEPA or similar protocols.

FIG. 1 shows a concept of integrated and automated network management based IEEE802.1Qbg edge virtual bridging (EVB) technology.

Referring to FIG. 1, IEEE802.1Qbg technology is core technology for automated control and management of the IDC network, and supports smart setup of a cloud server area and a network area to avoid complicated and time-consuming operation upon manually managing the cloud server area and the network area.

That is, the continuity and quality of the cloud service may be guaranteed through real-time integrated and automated management and control between network resources and virtual resources of the cloud. For example, migration between network servers of the virtual machines may be supported. Also, it is possible to maximize the use of cloud resources and network resources in the IDC and save operation management cost through consistent operation.

The network manager 2 manages a network in the IDC center for providing a cloud service. Also, the network manager 2 manages and controls virtual station interface type information (hereinafter referred to as VSI type information), which is network attribute information used by a virtual machine of the first network device 10. In this case, the network manager 2 registers, deletes, or updates the VSI type information used by the virtual machine in the VSI type DB 14. For example, the network manager 2 may update a MAC address, one of VSI type attributes, to a new address.

The VSI type information may be manually managed. However, according to the present invention, the VSI type information may be automatically managed through the separate VSI type DB 14. The VSI type DB 14 may be any server. The VSI type information includes a plurality of attributes needed for virtualization service through a virtual machine, such as a virtual LAN identifier (VLAN ID), a MAC address, Quality of Service (QoS) control information, an access control list (ACL), and security control information.

Referring to FIG. 1, a VSI type automated management process includes generating, by the network manager 2, the VSI type information used by the virtual machine in the VSI type DB 14 managed by the VSI manager 4, retrieving and acquiring, by the virtual machine manager 3, available VSI type information from the VSI type DB 14, setting, by the virtual machine manager 3, the VSI type information and virtual machine, discovering and configuring VSI between the first network device 10 and the second network device 12, and requesting, by the second network device, the VSI type information used by the virtual machine from the VSI type DB 14 managed by the VSI manager 4, receiving the VSI type information, and then setting the network on the basis of the VSI type information.

The virtual machine of the first network device 10 using specific VSI type information requests the second network device 12 directly connected to the first network device 10 to set the VSI type to be used by the virtual machine, and provides the network service to the virtual machine on the basis of attributes about the VSI type. Thus, it is possible to integratedly and automatically manage and control the virtual machine and the network, thereby guaranteeing the continuity and quality of the virtual machine.

However, the setting of the network device is a very sensitive issue. That is, network connectivity of the virtual machine may be damaged due to wrong network setting, thus resulting in interruption of the cloud service provided by the IDC. It is obvious that the cloud manager 1 and the network manager 2 need to efficiently operate network setting without cloud service being interrupted and while guaranteeing service quality even when the state of the virtual machine is changed (for example, booting, interruption, and migration of the virtual machine).

In order for such efficient operation, VSI discovery and configuration protocol (VDP), part of IEEE802.1Qbg edge virtual bridging standard technology, is used between the first network device 10 and the second network device 12. VDP is protocol technology for automating network setting on the basis of the VSI type information set between the first network device 10 to which the virtual machine migrates and the second network device 12.

The second network device 12 requests and receives the VSI type information from the VSI type DB 14 for a specific virtual machine of the first network device 10, and sets a network for the virtual machine using the received VSI type information.

If the second network device 12 receives a packet having content modified with malicious intent such as hacking during communication between the second network device 12 and the VSI type DB 14 and sets a network, it makes a serious network problem and eventually allows continuity and quality of the cloud service to be difficult to guarantee. However, manual setting of the VSI type without the VSI type DB 14 in order to avoid these problems is complicated and not suitable for a large-scale IDC network.

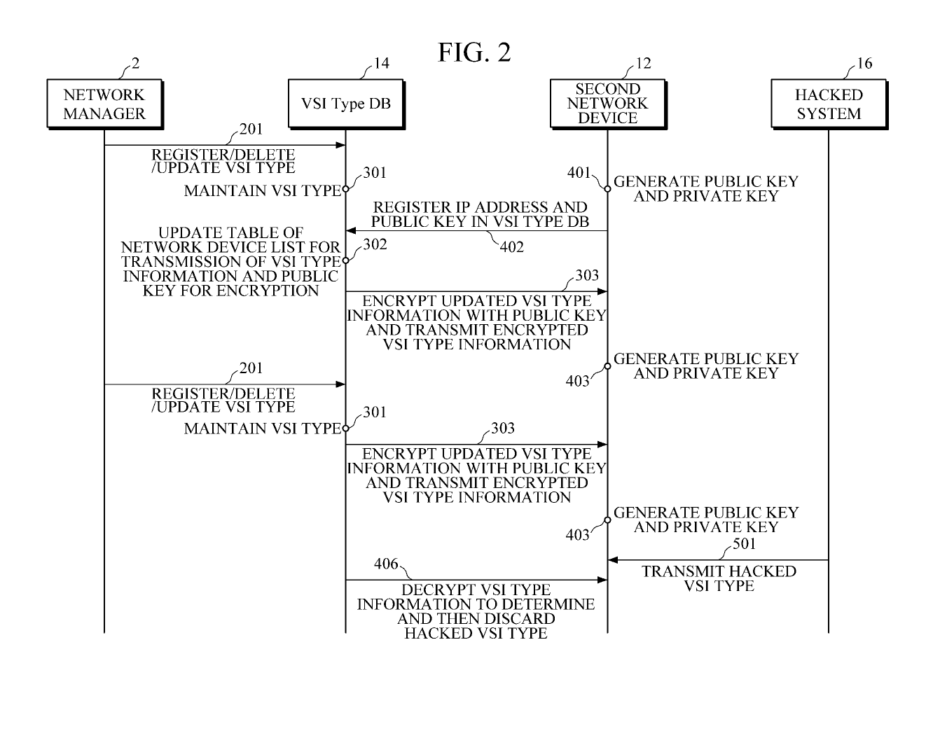

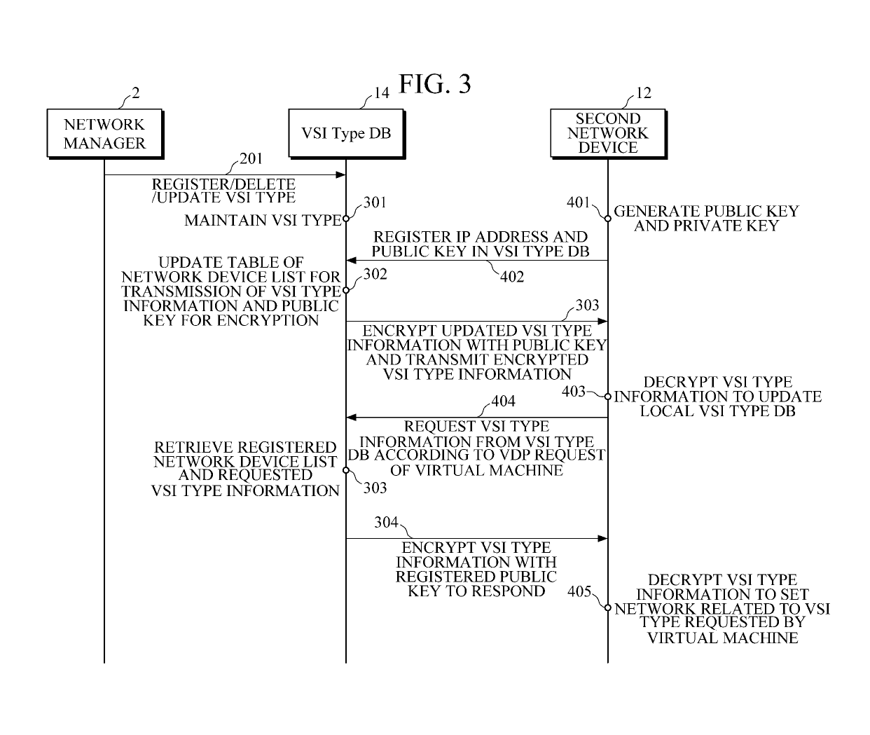

The present invention relates to a method of safely transmitting the VSI type information between the second network device 12 and the VSI type DB 14 in order to solve the above problems. According to the present invention, it is possible to prevent wrong network settings due to a malicious attack such as hacking in advance. FIGS. 2 and 3 are exemplary diagrams showing methods of safely transmitting the VSI type information according to various embodiments of the present invention. It will be appreciated that the VSI type information may be transmitted using any other safe methods.

FIG. 2 is a flowchart showing a control message flow for transmitting VSI type information between the VSI type DB 14 and the second network device 12 of an IDC center for providing a cloud service.

Referring to FIGS. 1 and 2, the network manager 2 manages a network in the IDC center for providing the cloud service, and registers, deletes, or updates the VSI type used by the virtual machine, and maintains the VSI type DB 14. In this case, the network manager 2 registers, deletes, or updates the VSI type information used by the virtual machine, in the VSI type DB 14.

The VSI type DB 14 builds and manages a database of the VSI type attributes registered, deleted, or updated by the network manager 2, and transmits the VSI type information in response to the request of the second network device 12 or transmits the VSI type attributes to the network device 12 registered in the updated VSI type DB 14.

The second network device 12 is equipment connected to the first network device 10 in which the virtual machine is executed, which receives a network setting request for the virtual machine and sets the network.

FIG. 2 shows a control flowchart for safely transmitting the VSI type information having a changed attribute to the second network device 12 in the VSI type DB 14 when the attribute of the VSI type information of the VSI type DB 14 is changed by the network manager 2.

The network manager 2 registers, deletes, or updates the VSI type information in the VSI type DB 14 of the VSI manager 4 (201), and the VSI manager 4 maintains the VSI type information having the changed attribute in the VSI type DB 14 (301). The second network device 12 generates a public key and a private key for encryption and decryption of the VSI type information (401), and registers its IP address and public key in the VSI type DB 14 registered in the second network device 12 (402). The VSI type DB 14 updates a table for mapping a list of the second network device 12 that will transmit the VSI type information onto the public key that will be encrypted (302), and encrypts the VSI type information having the changed attribute with the public key registered in the second network device 12 to transmit the encrypted VSI type information to the second network device 12 (303).

The second network device 12 decrypts the VSI type information transmitted from the VSI type DB 14 with the private key to determine appropriateness of the VSI type information. The second network device discards the VSI type information if the VSI type information is determined not to be appropriate. Unlike this, the second network device updates the attribute of the VSI type information in the local VSI type DB if the VSI type information is determined to be appropriate. With the above method, the network manager 2 can safely transmit the VSI type information having the changed attribute to the second network device 12.

According to a further embodiment, the network device 12 receives hacked network attribute information from a hacked system 16, and then decrypts the received network attribute information with the private key to determine appropriateness of the network attribute information and discard the network attribute information if it is not appropriate.

FIG. 3 is a flowchart illustrating a control message flow for transmitting the VSI type information between the VSI type DB 14 and the second network device 12 of the IDC center for providing a cloud service according to another embodiment of the present invention.

Referring to FIGS. 1 and 3, the network manager 2 registers, deletes, or updates the VSI type information in the VSI type DB 14 of the VSI manager 4 (201), and the VSI manager 4 maintains the VSI type information having the changed attribute in the VSI type DB 14 (301). The second network device 12 generates and manages a public key and a private key for encryption and decryption of the VSI type information (401), and registers its IP address and public key in the VSI type DB 14 registered in the second network device 12 (402). The VSI type DB 14 updates a table for mapping a list of the second network device 12 that will transmit the VSI type information onto the public key that will be encrypted (302), and encrypts the VSI type information having the changed attribute with the public key registered in the second network device 12 to transmit the encrypted VSI type information to the second network device 12 (303).

The second network device 12 decrypts the VSI type information transmitted from the VSI type DB 14 with the private key to determine appropriateness of the VSI type information. The second network device discards the VSI type information if the VSI type information is determined not to be appropriate. Unlike this, the second network device updates the attribute of the VSI type information in the local VSI type DB if the VSI type information is determined to be appropriate. With the above method, the network manager 2 can safely transmit the VSI type information having the changed attribute to the second network device 12.

According to a further embodiment, the second network device 12 receives a VDP message for requesting network setting needed for a virtual machine from the first network device 10 having the virtual machine, and then retrieves the VSI type information contained in the VDP message from the local VSI type DB. As a result of the retrieval, if there is the VSI type information, the second network device 12 performs the network setting using the VSI type information. If there is no VSI type information, the second network device 12 requests and acquires the VSI type information from the VSI type DB 14. Then, the VSI type DB 14 retrieves the list of the registered second network device 12 and the VSI type information requested by the second network device 12.

Next, the VSI type DB 14 encrypts the retrieved VSI type information with the registered public key to transmit the encrypted VSI type information to the second network device 12 (304). Then, the second network device 12 decrypts the VSI type information with the private key and then sets a network needed for the virtual machine using the VSI type information. Also, the second network device 12 updates the attribute of the VSI type information of the local VSI type DB.

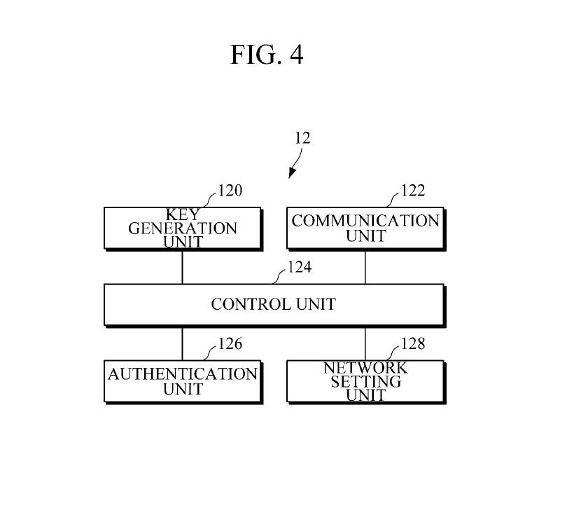

FIG. 4 is a block diagram showing a second network device 12 according to an embodiment of the present invention.

Referring to FIGS. 1 and 4, the network device 12 includes a key generation unit 120, a communication unit 122, a control unit 124, an authentication unit 126, and a network setting unit 128.

The key generation unit 120 generates a public key and a private key for encryption and the decryption of the network attribute information to be used by the virtual machine of the first network device 10. The network attribute information is VSI type information and includes a virtual LAN identifier, a MAC address, Quality of Service control information, an access control list, security control information, etc.

The communication unit 122 provides a public key generated by the key generation unit 120 to the VSI type DB 14, and receives encrypted network attribute information from the VSI type DB 14 when the VSI type DB 14 encrypts the network attribute information with the public key. The authentication unit 126 decrypts the network attribute information received through the communication unit 122 with the private key to determine appropriateness of the network attribute information and then update the local VSI type DB.

The network setting unit 128 sets a network for the virtual machine using the network attribute information authenticated through the authentication unit 126. The network setting unit 128 may automatically set a network using a VSI discovery and configuration protocol (VDP). The control unit 124 controls each element.

According to an embodiment, if the communication unit 122 receives hacked network attribute information from a hacked system, the authentication unit 126 decrypts the received network attribute information with the private key to determine appropriateness of the network attribute information and discard the network attribute information if it is not appropriate.

The communication unit 122 receives a request for setting of the network to be used by the virtual machine from the first network device 10, and requests network attribute information from the VSI type DB 14. Also, the communication unit 122 receives the network attribute information encrypted through the public key from the VSI type DB 14. At this point, the authentication unit 126 decrypts the received network attribute information with the private key to determine appropriateness of the network attribute information.

According to an embodiment, it is possible to guarantee the continuity and quality of the cloud service by applying an authentication and encryption system and then safely transmitting network attribute information to reduce damage due to network setting through hacking.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A network management method of a network device connected to a network server, the network management method comprising:
generating a public key and a private key for encryption and decryption of network attribute information to be used by a virtual machine positioned in the network server to provide the generated public key to a database;
receiving network attribute information encrypted by the database with the public key from the database; and
decrypting the received network attribute information with the private key to authenticate the network attribute information.

2. The network management method of claim 1, wherein the network attribute information is virtual station interface type information.

3. The network management method of claim 2, wherein the virtual station interface type information comprises at least one of a virtual LAN identifier, a MAC address, Quality of Service control information, an access control list, and security control information.

4. The network management method of claim 1, wherein the authenticating of the network attribute information comprises receiving hacked network attribute information from a hacked system, decrypting the received network attribute information with the private key to determine appropriateness of the network attribute information, and discarding the network attribute information.

5. The network management method of claim 1, further comprising setting a network for the virtual machine using the authenticated network attribute information.

6. The network management method of claim 5, wherein the setting of the network comprises automatically setting the network using a virtual station interface discovery and configuration protocol.

7. The network management method of claim 1, further comprising:
receiving a request for network setting to be used by the virtual machine from the network server and then requesting the network attribute information from the database;
receiving the network attribute information encrypted with the public key from the database; and
decrypting the received network attribute information with the private key to authenticate the network attribute information and setting the network for the virtual machine using the authenticated network attribute information.

8. The network management method of claim 7, wherein the requesting of the network attribute information comprises:
determining whether the network attribute information contained in a network setting request message of the network server is in a local database; and
requesting the network attribute information from the database when the network attribute information is not in the local database.

9. The network management method of claim 1, wherein the network device connected with the network server is external to the network server in order to support communication between virtual machines.

10. A network management method of a database, the network management method comprising:
updating, by a network manager, network attribute information;
receiving a public key from a network device connected with a network server having a virtual machine;
updating a mapping table mapping the public key onto a network device list for receiving the network attribute information; and
encrypting the updated network attribute information with the received public key and then transmitting the network device according to the updated mapping table.

11. The network management method of claim 10, further comprising:
receiving the network attribute information from the network device according to the request of the network server;
retrieving the registered network device list and the requested network attribute information according to the network attribute information request; and
encrypting the retrieved network attribute information with the public key to respond to the network device.

12. A network management apparatus comprises:
a key generation unit configured to generate a public key and a private key for encryption and decryption of network attribute information to be used by a virtual machine of a network server;
a communication unit configured to provide the public key generated by the key generation unit to a database, and when the database encrypts network attribute information with the public key, receive the encrypted network attribute information from the database; and
an authentication unit configured to decrypt the network attribute information received through the communication unit with the private key to authenticate the network attribute information.

13. The network management apparatus of claim 12, wherein the network attribute information is virtual station interface type information.

14. The network management apparatus of claim 13, wherein the virtual station interface type information comprises at least one of a virtual LAN identifier, a MAC address, Quality of Service control information, an access control list, and security control information.

15. The network management apparatus of claim 13, wherein, when the communication unit receives hacked network attribute information from a hacked system, the authentication unit decrypts the received network attribute information with the private key to determine appropriateness of the network attribute information and discard the network attribute information.

16. The network management apparatus of claim 12, wherein the communication unit receives a request for network setting to be used by the virtual machine from the network server, requests the network attribute information from the database, and receives the network attribute information encrypted with the public key from the database, and
the authentication unit decrypts the network attribute information received through the communication unit with the private key to determine appropriateness of the network attribute information.

17. The network management apparatus of claim 12, further comprising a network setting unit configured to set a network for the virtual machine using the network attribute information authenticated by the authentication unit.

18. The network management apparatus of claim 17, wherein the network setting unit automatically sets the network using a virtual station interface discovery and configuration protocol.
